(19) United States
(12) Patent Application Publication
(10) Pub. No.: US 2018/0011813 A1
(43) Pub. Date: Jan. 11, 2018

(54) SERIAL MID-SPEED INTERFACE

(71) Applicant: INTEL IP CORPORATION, Santa Clara, CA (US)

(72) Inventors: Eytan Mann, Modiin (IL); Gilad Nahor, Modiin (IL); Guy Kaminitz, Kfar-Saba (IL)

(21) Appl. No.: 15/202,910

(22) Filed: Jul. 6, 2016

(51) Int. Cl. G06F 13/42; G06F 1/10; G06F 1/32; G06F 13/40

(52) U.S. Cl. CPC G06F 13/4282; G06F 13/4022; G06F 1/10; G06F 1/3287

(57) ABSTRACT

In accordance with embodiments disclosed herein, there is provided systems and methods for a serial mid-speed interface. A first component includes a phase-locked loop (PLL) to receive an input clock signal and to output an output signal, an interface controller including a clock-management state machine, and a transmitter. The interface controller is to receive the input clock signal, receive the output signal from the PLL, and generate a speed-switch packet. The transmitter is to transmit a first plurality of packets to a second component at a clock rate based on the clock signal via a mid-speed interface, transmit the speed-switch packet to the second component, and transmit a second plurality of packets to the second component at a PLL rate based on the output signal, where the PLL rate is greater than the clock rate.

### BRIEF DESCRIPTION OF THE DRAWINGS

FIG. 1A illustrates a system of a first component coupled to a second component via a mid-speed interface in an interconnect architecture, according to one embodiment.

FIG. 1B illustrates a system of a first component coupled to a second component via a mid-speed interface in an interconnect architecture, according to another embodiment.

FIG. 2 illustrates a pins diagram of a first component coupled to a second component via a mid-speed interface, according to one embodiment.

FIG. 3 illustrates a services diagram of a first component coupled to a second component via a mid-speed interface, according to one embodiment.

FIG. 4 is a timing diagram 400 of a first component 105 coupled to a second component 110 via a mid-speed interface 115, according to one embodiment.

FIG. 5A is a flow diagram of a method of transmission via a mid-speed interface, according to one embodiment.

FIG. 5B is a flow diagram of a method of transmission via a mid-speed interface, according to another embodiment.

FIG. 6 illustrates a computing system with multiple interconnects with a mid-speed interface, according to one embodiment.

FIG. 7 illustrates a block diagram of a multicore processor, according to one embodiment.

FIG. 8 illustrates a system on a chip (SOC) design, according to one embodiment.

FIG. 9 illustrates a block diagram for a computing system, according to one embodiment.

### DESCRIPTION OF EMBODIMENTS

Components communicate with each other over a communication path. A first component may be an integrated component (e.g., system on a chip (SoC)) and a second component may be a peripheral component (e.g., radio frequency (RF) component, a camera, and so forth). There is integration of connectivity functions (e.g., WiFi®, Bluetooth®, global navigation satellite system (GNSS), frequency modulation radio (FMR), near field communication (NFC), Wireless Gigabit Alliance (WiGig), and so forth) into the integrated component (e.g., SoC). Embodiments described herein are directed to interconnect technology with a generic communication path between the integrated component and the peripheral component. The generic communication path may be full duplex to allow multiple transactions to be executed at the same time and to provide reasonable latency, may allow multiple services, may be a highly reliable interface, and may facilitate power saving when the interface is not in use.

Conventional solutions (e.g., universal asynchronous receiver/transmitter (UART), secure digital input output (SDIO), Peripheral Component Interconnect Express (PCIe®), and so forth) each have drawbacks. For example, UART may be too slow for some applications. SDIO is not full duplex and has too many pins for some applications. PCIe® has a large overhead complex design with a large silicon area and uses many pins for some applications.

To avoid these drawbacks, in the embodiments described herein, an interface can have a faster interface (e.g., about twenty times faster than the UART interface), the packet length can be fixed length of 27, 33, or 44 bits (e.g., much longer than UART, able to complete transactions in a single packet in some instances), and the packets may be oversampled (e.g., greater than eight times) at the receiver to recover the packet. The interface may use a system phase-locked loop (PLL) instead of a dedicated PLL.

The interface, in the embodiments described herein, may have a much faster bit rate compared to UART and SDIO. The interface, in the embodiments described herein, may have a much lower power compared to PCIe® (e.g., much lower latency to start transport, power gain is deeper during park state that the whole controller can be powered off, only input output (IO) pads may stay alive to facilitate wake feature). The interface, in the embodiments described herein, may have a fixed packet length (e.g., the worst case latency is fully controlled), and the packet may be much longer (e.g., can complete the transaction in important cases within a single packet). The interface, in the embodiments described herein, may be implemented in the silicon with a tiny area and ball count (e.g., only two pins).

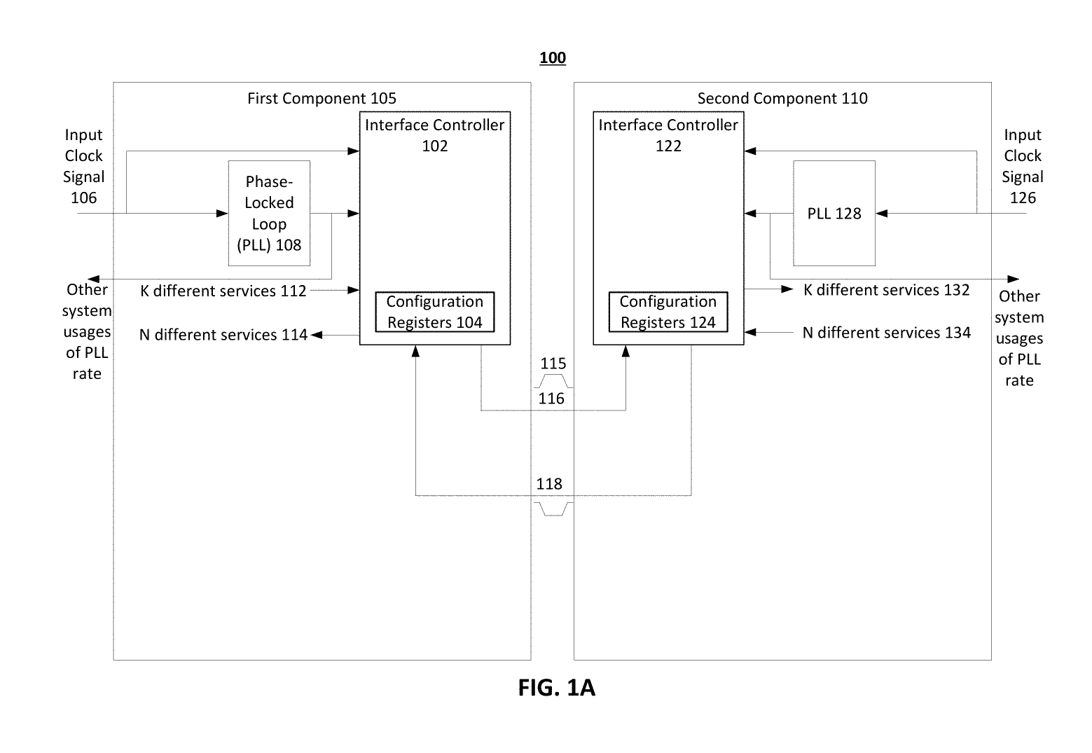

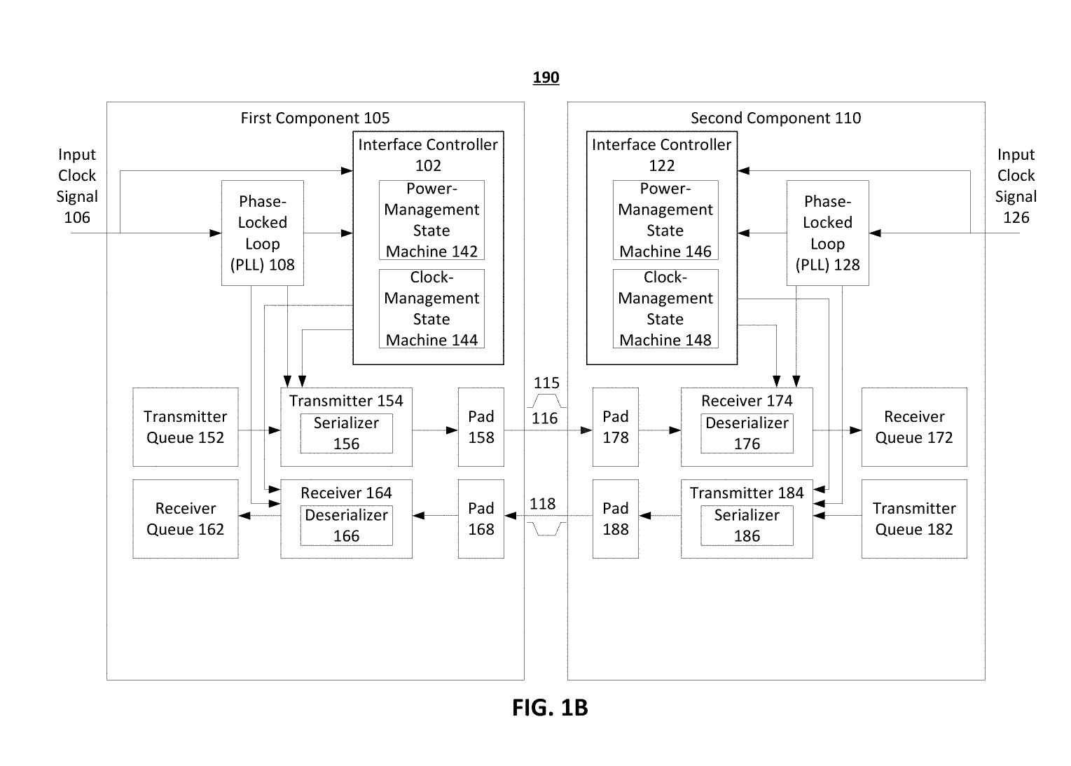

FIG. 1A illustrates a system 100 of a first component 105 coupled to a second component 110 via a mid-speed interface 115 (e.g., the combination of 116 and 118) in an interconnect architecture, according to one embodiment. In one embodiment, FIG. 1A illustrates a serial point-to-point link that includes any transmission path for transmitting serial data. In another embodiment, FIG. 1A illustrates a point-to-point fabric.

Devices communicate with one another over an interface (e.g., interconnect, link, and so forth). A link may be a point-to-point communication channel between two components, allowing both components to send and receive requests and responses. The components may send messages to each other and receive messages from each other over one or more lanes. In one embodiment, at the physical level, a link is composed of one or more lanes, where one lane is composed of two differential signaling pairs; one pair for receiving data and one pair for transmitting data. In another embodiment, a lane is not two different signaling pairs, but is single ended.

The mid-speed interface 115 may enable components and devices from different vendors to inter-operate in an open architecture, spanning multiple market segments; Clients (Desktops and Mobile), Servers (Standard and Enterprise), and Embedded and Communication devices. The mid-speed interface 115 may be a high performance, general purpose I/O interconnect defined for a wide variety of future computing and communication platforms. The mid-speed interface 115 may be a highly scalable, fully serial interface. The mid-speed interface 115 may take advantage of advances in point-to-point interconnects, Switch-based technology, and packetized protocol to deliver new levels of performance and features. One or more of Power Management, Quality of Service (QoS), Hot-Plug/Hot-Swap support, Data Integrity, and Error Handling may be supported by the mid-speed interface 115.

The mid-speed interface 115 may include a first data line 116 and a second data line 118. The first component 105 may include an interface controller 102 that includes configuration registers 104 and the second component 110 may include an interface controller 122 that includes configuration registers 124.

The first component 105 may be coupled to a phase-locked loop (PLL) 108. In one embodiment, the first component 105 includes the PLL 108. In another component, the PLL 108 is a system PLL that outputs an output signal to a circuit in addition to the interface controller 102. In another embodiment, the PLL 108 is separate from the first component 105.

The second component 110 may be coupled to a PLL 128. In one embodiment, the second component 110 includes the PLL 128. In another component, the PLL 128 is a system PLL that outputs an output signal to a circuit in addition to the interface controller 122. In another embodiment, the PLL 128 is separate from the second component 110.

The first component 105 may transmit packets and signals to the second component 110 via the first data line 116 and the second component 110 may transmit packets and signals to the first component 105 via the second data line 118. For example, interface controller 102 may receive K different services 112 in first component 105, interface controller 102 may transmit the K different services to interface controller 122 via data line 116, and interface controller 122 may transfer the K different services 132 to second component 110. In one embodiment, the quantity of K different services 132 is less than the quantity of K different services 112. In another embodiment, the quantity of K different services 132 is the same as the quantity of K different services 112. In another example, interface controller 122 may receive N different services 134 in second component 110, interface controller 122 may transmit the N different services to interface controller 102 via data line 118, and interface controller 122 may transfer the N different services 114 to first component 105. In one embodiment, the quantity of N different services 114 is less than the quantity of N different services 134. In another embodiment, the quantity of N different services 114 is the same as the quantity of N different services 134.

FIG. 1B illustrates a system 190 of a first component 105 coupled to a second component 110 via a mid-speed interface 115 in an interconnect architecture, according to another embodiment.

The first component 105 may include an interface controller 102 that includes a power-management state machine 142 and a clock-management state machine 144. The first component 105 may include a transceiver that includes the transmitter 154 and the receiver 164. The transmitter 154 may include a serializer 156 and the receiver 164 may include a deserializer 166. The transmitter 154 may be coupled to the PLL 108, the interface controller 102, transmitter queue 152, and pad 158. The receiver 164 may be coupled to the PLL 108, the interface controller 102, receiver queue 162, and a pad 168. The second component 110 may also include an interface controller 122 that includes a power-management state machine 146 and a clock-management state machine 148. The second component 110 may also include a transceiver that includes a transmitter 184 and a receiver 174. The transmitter 184 may include a serializer 186 and the receiver 174 may include a deserializer 176. The transmitter 184 may be coupled to the PLL 128, the interface controller 122, transmitter queue 182, and pad 188. The receiver 174 may be coupled to the PLL 128, the interface controller 122, receiver queue 172, and pad 178.

The first component 105 may include a PLL 108 to receive an input clock signal 106 and to output an output signal. The first component may include an interface controller 102 coupled to the PLL 108, the transmitter 154, and the receiver 164. The interface controller 102 may receive the input clock signal 106 and receive the output signal from the PLL 108. The interface controller 102 may generate, by the clock-management state machine 144, a speed-switch packet. The transmitter 154 may transmit a first plurality of packets to a second component 110 at a clock rate based on the clock signal 106 via a mid-speed interface 115. The mid-speed interface may be a serial interface. Starting at a clock rate (e.g., 2 to 5 Mbits/second, slower than the PLL rate) may allow confirmation that the interface will operate correctly when go to higher frequency. In one embodiment, the clock speed is 20-50 MHz which may be fast enough to properly resolve packets and apply the configuration registers to be fixed to allow full speed of the interface.

The transmitter 154 may receive a speed-switch packet from the interface controller 102 and the transmitter 154 may transmit the speed-switch packet to the second component 110 via the mid-speed interface 115 subsequent to the first plurality of packets. In one embodiment, the first component 105 transmits the speed-switch packet to the second component once there has been confirmation that the interface is operating correctly at the clock rate. The first component 105 and second component 110 may not use a training frequency and the second component 110 may not send an acknowledgement of receiving the speed switch packet.

Before the transmitter 154 transmits the speed-switch packet, the transmitter 154 may transmit a first plurality of packets to the second component 110 via the mid-speed interface 115 at a clock rate (e.g., 2 to 5 Mbits/second). After the transmitter 154 transmits the speed switch packet, the transmitter 154 may transmit a second plurality of packets to the second component 110 via the mid-speed interface 115 at a PLL rate (e.g., 20 to 200 Mbits/second, about 80 Mbits/second, and so forth) based on the output signal from the PLL 108. The PLL rate may be greater than the clock rate.

The interface controller 102 may generate, by the power-management state machine 142, a going-to-park packet and transmit the going-to-park packet to the transmitter 154. The transmitter may transmit the going-to-park packet to the second component 110. In response to transmission of the going-to-park packet to the second component 110, the interface controller 102 may change the first component 105 from an operating power state to a park power state, where the park power state is lower than the operating power state. In the park power state, one or more clocks may be gated to reduce the current consumption, the interface controller 102 and the serializer 156 may be turned off, the interface signals may be set to opposite from the default of the active level, and both the first component 105 and second component 110 may be in the park power state. In the park power state, the entire interface controller may be powered off and only the 10 pads (e.g., pads, pads and IO mux, or IO mux) may stay powered to facilitate a wake feature (e.g., going out of park). The initiation of the park power state may always be from the integrated component (e.g., first component 105, SoC, and so forth) by sending the going-to-park packet. After transmitting the going-to-park packet from the first component 105 to the second component 110, a sequence of “parking” (e.g., turning off components) occurs and ends with both sides being inactive. When first component 105 or second component 110 is at park, packets may not be sent, but going out of park may be an asynchronous channel operation via the pads (e.g., pad 158, pad 168, pad 178, pad 188). For example, the first component 105 or second component 110 may generate, by the power-management state machine, a going-out-of-park sequence, instruct the transmitter 154, pad 158, transmitter 184, or pad 188 to transmit the going-out-of-park sequence to the opposing component (e.g., first component 105, second component 110), and change the first component 105 or second component 110 from the park power state to the operating power state in response to transmission of the going-out-of-park sequence.

The interface controller 102 may detect a received sequence of a specified number of same bits (e.g., a specified length of zeros) and self-reset the receiver 164.

The transmitter 154 may transmit fixed length packets. Each fixed length packet may be 27 bits or 44 bits and each fixed length packet may not include a stop bit. Each packet includes a start bit, a header (e.g., an arbitrary length such as 3 bits), data, an optional error correction code (e.g., ECC, single error correction, two error detection), and no stop bit. The start bit may be detected by the change of the line from 0 to 1 (if the line is not active; 1 is the start bit). The number of samples of the PLL clocks is a rational fraction (M/N, where M and N are integers) of the bit rate. The counter in the interface controller will auto compensate for the M/N delta (few 10s of parts per million (PPM) difference between the clocks). Every M/N bits a bit is extracted from the stream (once the start bit is found).

In one embodiment, input clock signal 106 is 40 MHz and input clock signal 126 is 38.4 MHz, output of PLL 108 is 640 MHz (40*16), output of PLL 128 is 624 MHz (38.4*16.25), data speed from first component 105 to second component 110 is 80 Mbits/second (40*2), so M/N=624/80=7.8. Data speed from second component 110 to first component 105 is 76.8M (38.4*2), so M/N of the SOC is 640/76.8=8.33.

At low speed, the interface controller does not utilize the PLL operation and will simply use the clock speed divided by a large margin (e.g., 8) and as such will give wide margins so that data can be recovered at this speed. At this speed, both the first component 105 and the second component 110 may negotiate the speed and settings.

The bits may be oversampled (e.g., greater than eight times) to recover the bits into and build packets. The receive oversample may be implemented using the system PLL (e.g., not a dedicated PLL). In another embodiment, the fixed length packet is 33 bits. The first component 105 may establish a full duplex communication channel and the first component 105 and the second component 110 may to perform a full handshake.

The first component 105 may include a first terminal (e.g., pad 158) and a second terminal (e.g., pad 168), the first terminal being coupled to a first data line 116 of the mid-speed interface 115 and the second terminal being coupled to a second data line 118 of the mid-speed interface 115.

The second component 110 may include a PLL 128 to receive an input clock signal 126 and to output an output signal. The second component 110 may include an interface controller 122 coupled to the PLL 128. The interface controller 122 may receive the input clock signal 126 and receive the output signal from the PLL 128. The interface controller 122 may perform speed switch upon reception of a speed-switch packet. A transmitter 184 and receiver 174 may be coupled to the interface controller 122. The receiver 174 may receive a first plurality of packets from the first component 105 at a clock rate based on the clock signal 106 via a mid-speed interface 115. The transmitter 184 may transmit packets to the first component 105 at a clock rate based on the clock signal 126. The mid-speed interface 115 may be a serial interface. The receiver 174 may receive a speed-switch packet from the first component 105 via the mid-speed interface 115 subsequent to the first plurality of packets. In response to receiving the speed-switch packet, the transmitter 184 may transmit a second plurality of packets to the first component 105 via the mid-speed interface 115 at a PLL rate based on the output signal. The PLL rate may be greater than the clock rate. In one embodiment, the clock rate is 2 to 5 Mbits/second and the PLL rate is 20 to 200 Mbits/second. In another embodiment, the PLL rate is about 80 Mbits/second.

The second component may receive a going-to-park packet from the first component 105. In response to receiving of the going-to-park packet, the interface controller 122 may change the second component 110 from an operating power state to a park power state, where the park power state is lower than the operating power state. The park power state may be substantially similar or the same for first component 105 and second component 110.

The interface controller 122 may detect a received sequence of a specified number of same bits (e.g., a specified length of zeros) and self-reset the receiver 174.

The transmitter 184 may transmit fixed length packets. Each fixed length packet may be 27 bits or 44 bits and each fixed length packet may not include a stop bit. In another embodiment, the fixed length packet is 33 bits. The second component 110 may establish a full duplex communication channel and the first component 105 and the second component 110 may to perform a full handshake.

The second component 110 may include a first terminal (e.g., pad 178) and a second terminal (e.g., pad 188), the first terminal being coupled to a first data line 116 of the mid-speed interface 115 and the second terminal being coupled to a second data line 118 of the mid-speed interface 115.

A transmission path refers to any path for transmitting data, such as a transmission line, a copper line, an optical line, a wireless communication channel, an infrared communication link, or other communication path. A connection between two devices or components, such as the first component 105 and second component 110, is referred to as a link (e.g., a transmission medium), such as mid-speed interface 115. The components communicate via a logical connection called an interconnect or link. A link is a point-to-point communication channel between two ports allowing both of them to send and receive packets (e.g., configuration, I/O or memory read/write, INTx, MSI, or MSI-X). At the physical level, a link is composed of one or more lanes. Low-speed peripherals (such as a card using the 802.11 Wi-Fi® technology) use a single-lane (×1) link, while a graphics adapter typically uses a much wider and faster 16-lane link. A link between two components includes one or more lanes. The one or more lanes are simplex channels using differential signaling. Conceptually, each lane is used as a full-duplex byte stream, transporting data packets in eight-bit “byte” format simultaneously in both directions between endpoints of a link. Links may contain from one to 32 lanes, more precisely 1, 2, 4, 8, 12, 16 or 32 lanes. Lane counts are written with an “×” prefix (for example, “×8” represents an eight-lane card or slot), with ×16 being the largest size in common use. To scale bandwidth, a link may aggregate multiple lanes denoted by ×N, where N is any supported Link width, such as 1, 2, 4, 8, 12, 16, 32, 64, or wider.

The bonded serial bus architecture may be chosen over the traditional parallel bus due to inherent limitations of the latter, including half-duplex operation, excess signal count, and inherently lower bandwidth due to timing skew. Timing skew results from separate electrical signals within a parallel interface traveling through conductors of different lengths, on potentially different printed circuit board (PCB) layers, and at possibly different signal velocities. Despite being transmitted simultaneously as a single word, signals on a parallel interface experience different travel times and arrive at their destinations at different moments. When the interface clock rate is increased to a point where its inverse (that is, its clock period) is shorter than the largest possible time between signal arrivals, the signals no longer arrive with sufficient coincidence to make recovery of the transmitted word possible. Interface 115 may be a source synchronizing interface (e.g., off the chip) which can operate at 4.5Gb/second over a single trace (e.g., data plus clock traces). In one embodiment, 3 data lanes plus clk may be used.

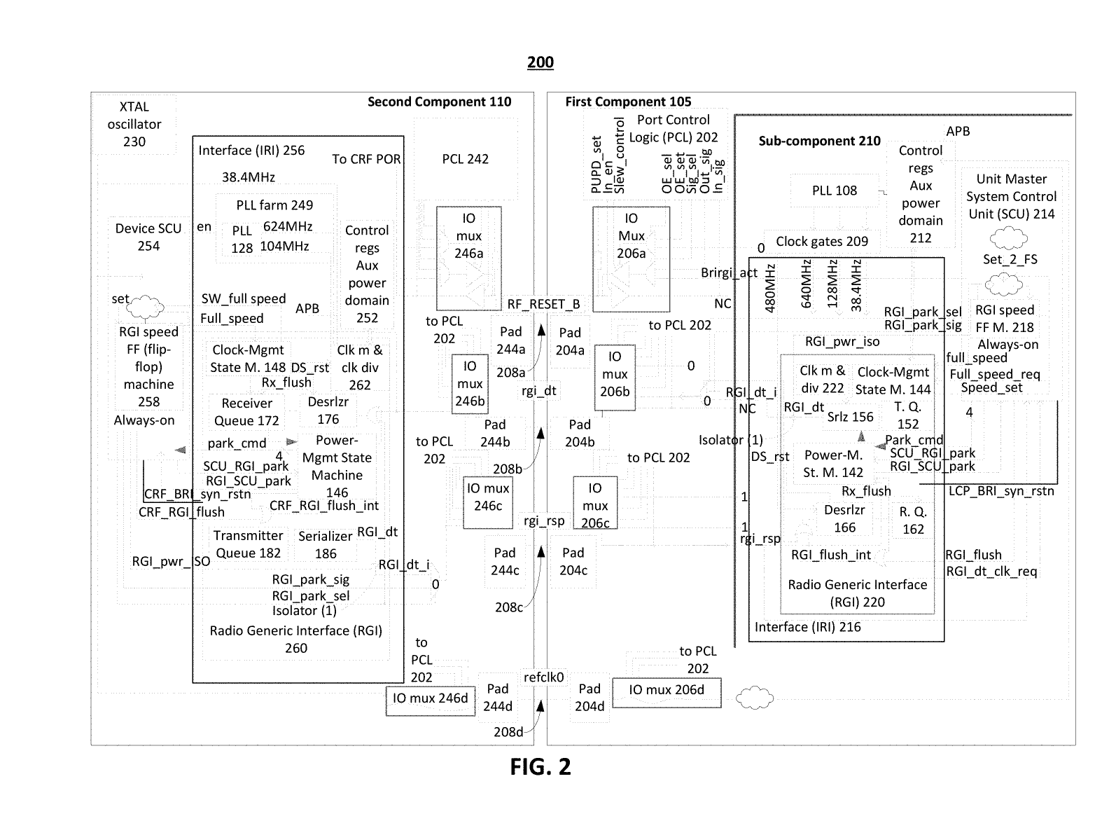

FIG. 2 illustrates a pins diagram 200 of a first component 105 coupled to a second component 110 via a mid-speed interface 115, according to one embodiment.

The first component 105 includes a port control logic (PCL) 202. In one embodiment, the PCL 202 may include a various controls that may multiplex on a single pin for functional and testing purposes. Similarly, PCL 242 may include the corresponding control for the second component port.

First component 105 may include one or more pads (e.g., pad 204a, pad 204b, pad 204c, pad 204d, and so forth (hereinafter “pad 204”). In one embodiment, each pad 204 is substantially 1.8V. In another embodiment, each pad 204 is a different value. Each pad 204 may be coupled to a corresponding input/output multiplexer (IO mux; e.g., pad 204a coupled to IO mux 206a, pad 204b coupled to IO mux 206b, pad 204c coupled to IO mux 206c, pad 204d coupled to IO mux 206d, and so forth; hereinafter “IO mux 206”) and each corresponding IO mux 206 may be coupled to the PCL 202.

In one embodiment, the pad 204a is coupled to a signal line 208a to reset the second component 110 (e.g., receive RF_reset_B).

In one embodiment, the pad 204b is coupled to a data line 208b to transfer data to the second component 110 (e.g., receive rgi_dt). Data line 208b may receive data from serializer 156 of the first component 105 to transfer to deserializer 176 of the second component 110. In one embodiment, data line 208b is data line 116.

In one embodiment, the pad 204c is coupled to a data line 208c to receive data from serializer 186 of the second component 110 to transfer to deserializer 166 of first component 105 (e.g., receive rgi_rsp). In another embodiment, the pad 204c is coupled to a data line 208c to receive a signal from the second component 110. In one embodiment, data line 208c is data line 118.

In one embodiment, the pad 204d is coupled to a data line 208d to receive a clock signal (e.g., refclk0). The IO mux 206d may transfer the clock signal to the PLL 108 and the PCL 202. The PLL 108 outputs one or more output signals (e.g., 640 MHz, 128 MHz, 38.4 MHz). The clock gates 209 may perform clock gating. In one embodiment, clock gating may reduce dynamic power dissipation. In another embodiment, clock gating may prune the clock tree (e.g., disable portions of the circuitry so that flip-flops do not have to switch states) to save power.

First component 105 may include a sub-component 210. The sub-component 210 may include one or more of PLL 108, clock gates 209, control register auxiliary power domain 212, system control unit (SCU) 214, and interface (IRI) 216. SCU 214 may include an RGI speed switch state machine and speed flip-flop(s) (FF(s)) memory 218. IRI 216 may include a radio generic interface (RGI) 220. The RGI 220 may include one or more of clock multiplexers and dividers 222, clock-management state machine 144, transmitter queue(s) 152, serializer 156, power-management state machine 142, receiver queue(s) 162, and deserializer 166.

Clock gates 209 may transmit a signal (e.g., a signal at 480 MHz) to deserializer 166 and deserializer may be coupled to receiver queue(s) 162.

The SCU 214 may initiate one (or more) park packets (e.g., Park_cmd) to power-management state machine 142. Power-management state machine 142 may transmit a park packet to second component 110. In one embodiment, a park packet is a going-to-park packet. The going-to-park packet may change the first component 105 from an operating power state to a park power state, where the park power state is lower than the operating power state. SCU 214 may detect an “un-park” sequence signaling on pad 204c and initiate out of park to active sequence. Park is initiated by the first component 105. Speed switch is also initiated by the first component 105.

The SCU 214 may set RGI speed FF machine 218 to speed switch. A full_speed_req signal asserts a speed switch packet is sent. Clock Management State Machine 144 sets the clocks correctly. The RGI Speed FF machine 218 is kept powered on until the full power cycle.

The deserializer 166 may transmit a receiver flush signal (e.g., Rx_flush) to receiver queue 162 to flush the receiver queue 162 (e.g., clear the queue; self-reset the receiver, and so forth).

The RGI 220 may be coupled to a control registers auxiliary power domain 212.

The second component 110 may include an XTAL oscillator 230, an SCU 254 including an RGI speed FF machine 258, PCL 242, IRI 256, IO mux 246a coupled to a pad 244a coupled to data line 208a, IO mux 246a coupled to a pad 244b coupled to data line 208b, IO mux 246c coupled to a pad 244d coupled to data line 208c, and IO mux 246d coupled to a pad 244d coupled to data line 208d. Each IO mux 246a, 246b, 246c, and 246d (hereinafter IO mux 246) may be coupled to the PCL 242. Each pad of second component 110 (e.g., 244a, 244b, 244c, and 244d) is hereinafter pad 244.

IRI 256 may include a PLL farm 249 including PLL 128, control registers auxiliary power domain 252, and RGI 260. RGI 260 may include one or more of a clock-management state machine 148, clock multiplexers and clock dividers 262, receiver queue 172, deserializer 176, power-management state machine 146, transmitter queue 182, and serializer 186. RGI 260 may be coupled to the control registers auxiliary power domain 252.

In one embodiment, the transmitter queue(s) 182 is coupled to the serializer 186 which is coupled to IO mux 246c which is coupled to pad which is coupled to data line 208c to transfer a signal or packet to first component 105.

In one embodiment, PLL 128 may send one or more output signals (e.g., 624 MHz, 104 MHz, and so forth) to clock multiplexers and clock dividers 262.

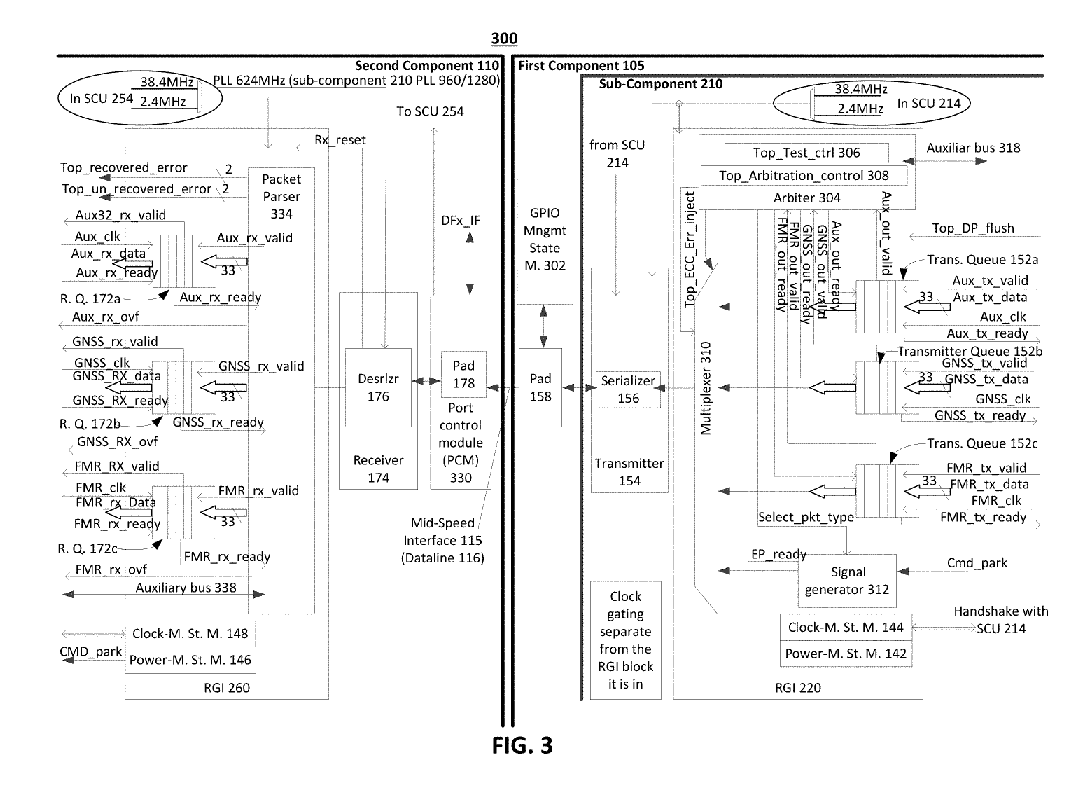

FIG. 3 illustrates a services diagram 300 of a first component 105 coupled to a second component 110 via a mid-speed interface 115, according to one embodiment. FIG. 3 illustrates only one direction of the flow, and similarly the opposite direction exists.

First component 105 may include one or more of a general purpose input/output (GPIO) management state machine 302, pad 158, and sub-component 210. Sub-component 210 may include one or more of an arbiter 304, a transmitter 154, a multiplexer 310, a signal generator (e.g., empty packet generation, go-to-park packet generation, speed switch signal, and so forth) 312, wall clock 314, clock-management state machine 144, and power-management state machine 142, and one or more transmitter queues 152 (e.g., transmitter queue 152a, 152b, 152c, hereinafter transmitter queue 152). The one or more transmitter queues 152 may each include a different type of data. For example, transmitter queue 152a may include auxiliary (Aux) data, transmitter queue 152b may include global navigation system (GNSS) data, and transmitter queue 152c may include frequency modulation radio (FMR) data.

The arbiter 304 may include Top_Test_ctrl 306 (e.g., to inject errors (few kinds), and so forth) and Top_Arbitration control 308 (e.g., determine how much data to collect before arbitration assuming Qout ready for popping out, arbitration priority settings, force gaps between packets, and so forth). The arbiter 304 may be coupled to an auxiliary bus 318.

Multiplexer 310 may receive packets or signals from one or more of transmitter queue 152a, transmitter queue 152b, transmitter queue 152c, signal generator 312, or wall clock 314. Multiplexer 310 may output one or more of the packets or signals that multiplexer 310 receives. The arbiter 304 may be coupled to one or more of the multiplexer 310, the wall clock 314, the signal generator 312, and transmitter queue 152. The arbiter 304 may control what packets or signals that multiplexer 310 transmits.

One or more of signal generator 312 or transmitter queue may receive data. In another embodiment, the arbiter 304 sends a packet selection signal (select_pkt_type) to signal generator 312 and signal generator 312 sends an empty packet signal (EP_ready) to arbiter 304. In another embodiment, transmitter queue 152c transmits a FMR_out_valid signal to arbiter 304 and arbiter sends a FMR_out_ready signal to transmitter queue 152c. In another embodiment, transmitter queue 152b transmits a GNSS_out_valid signal to arbiter 304 and arbiter sends a GNSS_out_ready signal to transmitter queue 152b. In another embodiment, transmitter queue 152a transmits an Aux_out_valid signal to arbiter 304 and arbiter sends an Aux_out_ready signal to transmitter queue 152a.

The serializer 156 may receive a speed signal from SCU 214 and data from multiplexer 310. Serializer may transmit the data to pad 158 which is coupled to GPIO management state machine 302. Pad 158 may transmit the data via mid-speed interface 115 (e.g., data line 116) to pad 178 port control module (PCM) 330 which delivers the data to deserializer 176 of receiver 174. Deserializer may be coupled to SCU 254 and RGI 260.

RGI 260 may include packet parser 334 (parser_checker_reassy), wallclock commands parser 336, clock-management state machine 148, power-management state machine 146, and one or more receiver queues 172 (e.g., receiver queue 172a, 172b, 172c, hereinafter receiver queue 172). The one or more receiver queues 172 may each include a different type of data. For example, receiver queue 172a may include Aux data, receiver queue 172b may include GNSS data, and receiver queue 172c may include FMR data.

The packet parser 334 may receive packets or signals from deserializer 176. In one embodiment, the packet parser 334 parses the packets into a corresponding receiver queue 172. In another embodiment, packet parser transmits the packets or signals to a wallclock commands parser 336. In another embodiment, the deserializer receives a reset signal and resets the receiver queues 172 in the RGI 260.

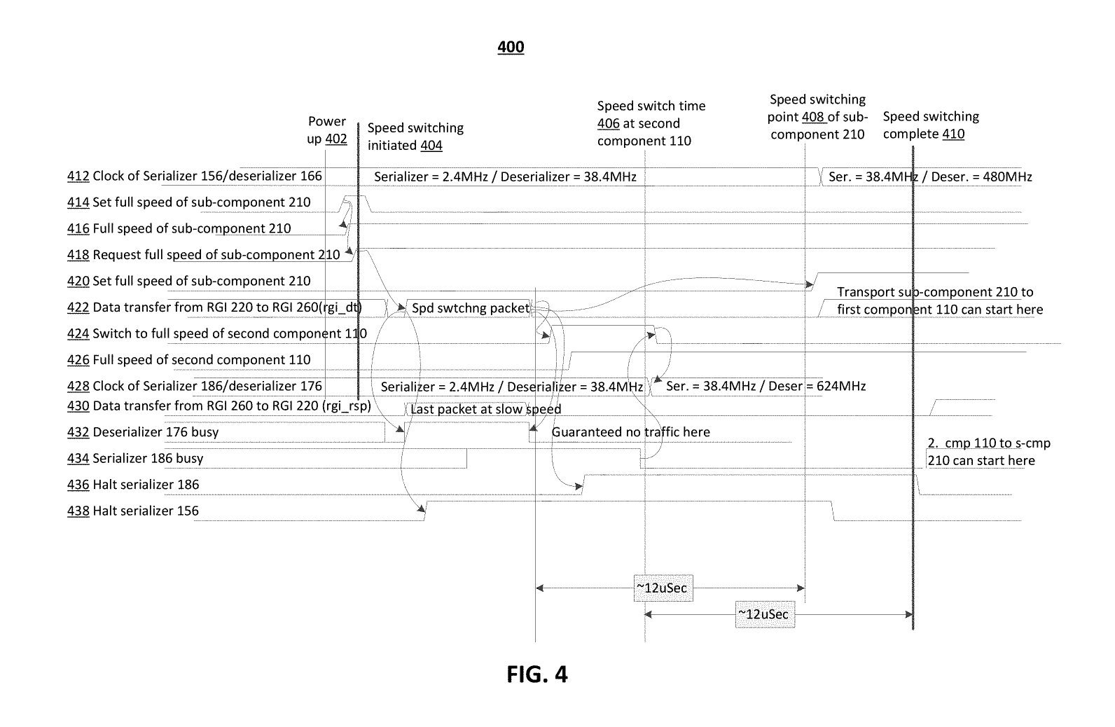

FIG. 4 illustrates a timing diagram 400 of a first component 105 coupled to a second component 110 via a mid-speed interface 115, according to one embodiment.

The stages of the timing diagram include power up 402, speed switching initiated 404, speed switch time 406 at second component 110, speed switching point 408 of sub-component 210, and speed switching complete 410. The time period between a speed switching packet and speed switching point 408 of sub-component 210 may be about 12 microseconds. The time period between speed switching point 408 of sub-component 210 and speed switching complete 410 may be about 12 microseconds.

At 412 (e.g., Serializer De-Serializer clock), the clock of serializer 156 is at 2.4 MHz before speed switching point of sub-component 210 and at 38.4 MHz after speed switching point of sub-component 210. At 412, clock of deserializer 166 is at 38.4 MHz before speed switching point of sub-component 210 and at 480 MHz after speed switching point of sub-component 210.

At 414 (e.g., set_2_FS), the full speed of sub-component 210 is set at speed switching initiated 404.

At 416 (e.g., full_speed), the full speed of sub-component 210 is at speed switching initiated 404 through speed switching complete 410.

At 418 (e.g., Full_Speed_req), the request for full speed of sub-component 210 is at speed switching initiated 404 through speed switching complete 410.

At 420 (e.g., Full_Speed_set), the full speed of sub-component 210 is set after speed switching point 408 of sub-component 210.

At 422 (e.g., rgi_dt), RGI 220 transfers a speed switching packet to RGI 260 after speed switching initiated 404 and RGI 220 transmits data packets to RGI 260 after speed switching point 408 of sub-component 210.

At 424 (e.g., CRF Sw_full_speed), second component 110 switches to full speed from after RGI 260 receiving the speed switching packet and until after the speed switch time 406 at second component 110.

At 426 (e.g., CRF full_speed), full speed of the second component 110 is from after RGI 260 receiving the speed switching packet.

At 428 (e.g., CRF Serializer/deserializer CLK), the clock of serializer 156 is at 2.4 MHz before speed switching time 406 of second component 110 and at 38.4 MHz after speed switching time 406 of second component 110. At 428, clock of deserializer 166 is at 38.4 MHz before speed switching time 406 of second component 110 and at 624 MHz after speed switching time 406 of second component 110.

At 430 (e.g., rgi_rsp), RGI 260 transfers a last packet at slow speed to RGI 220 during transmission of a speed switching packet from RGI 220 to RGI 260. RGI 260 may transfer another packet to RGI 220 after speed switching completes 410.

At 432 (e.g., CRF deserializer busy), deserializer 176 is busy during transfer of the speed switching packet from RGI 220 to RGI 260 and RGI 260 transferring the last packet at slow speed to RGI 220. In one embodiment, there is no traffic when the deserializer 176 is busy.

At 434 (e.g., CRF serializer busy), serializer 186 is busy from after transfer of the speed switching packet from RGI 220 to RGI 260 until speed switch time 406 at second component 110.

At 436 (e.g., CRF Serializer_halt), serializer 186 is halted from full speed of second component until speed switching complete 410.

At 438 (e.g., Serializer_halt), serializer 156 is halted from transfer of the speed switching packet until after speed switching point 408 of sub-component 210.

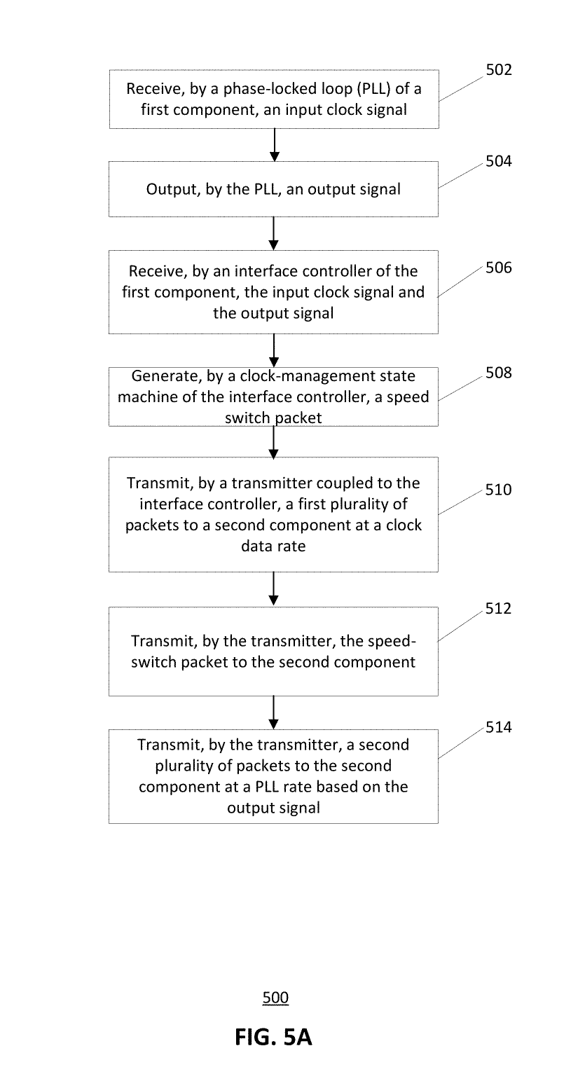

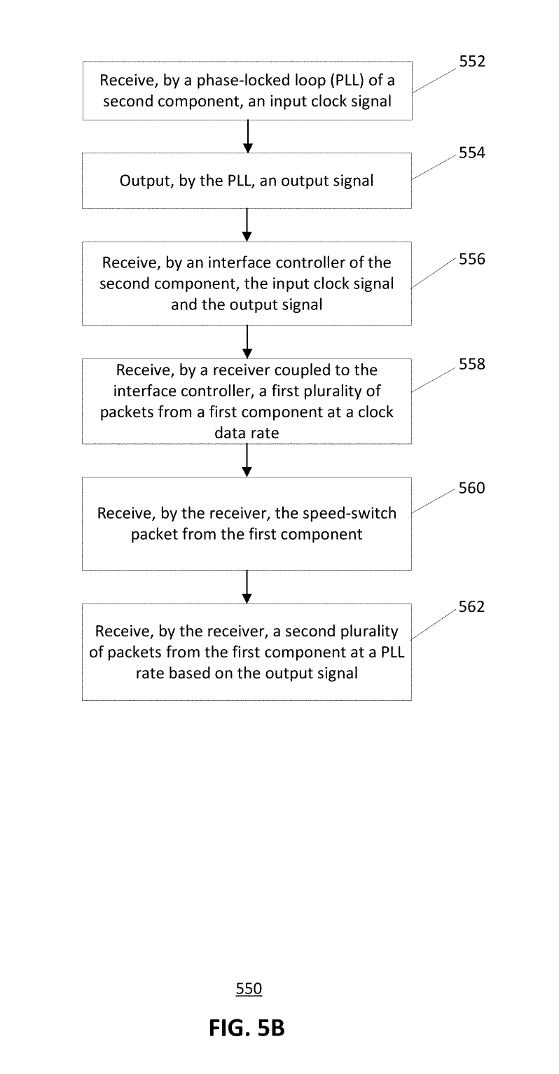

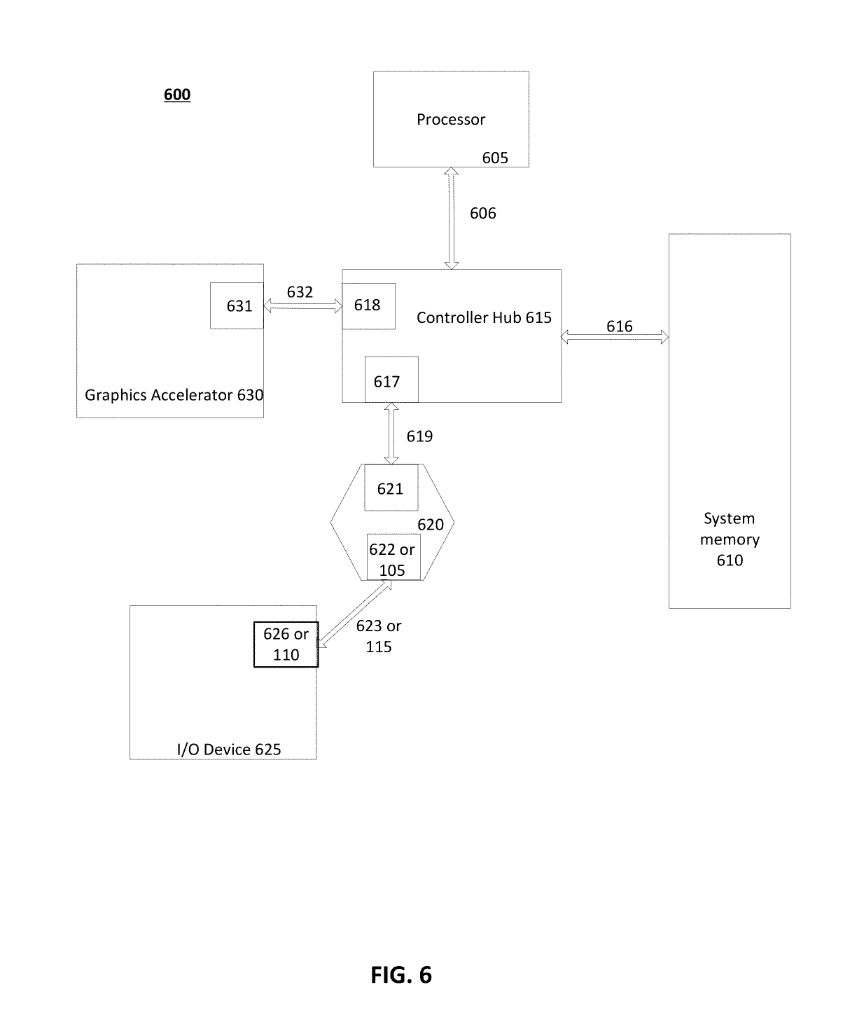

FIG. 5A is a flow diagram of a method 500 of transmission via a mid-speed interface 115, according to another embodiment. Method 500 may be performed by processing logic that may include hardware (e.g., circuitry, dedicated logic, programmable logic, microcode, etc.), software (such as instructions run on a processor, a general purpose computer system, or a dedicated machine), firmware, microcode, or a combination thereof. In one embodiment, method 500 may be performed, in part, by processor 605 of FIG. 6.

For simplicity of explanation, the method 500 is depicted and described as a series of acts. However, acts in accordance with this disclosure can occur in various orders and/or concurrently and with other acts not presented and described herein. Furthermore, not all illustrated acts may be performed to implement the method 500 in accordance with the disclosed subject matter. In addition, those skilled in the art will understand and appreciate that the method 500 could alternatively be represented as a series of interrelated states via a state diagram or events.

Referring to FIG. 5A, at 502 the processing logic receives, by a phase-locked loop (PLL) 108 of a first component 105, an input clock signal.

At block 504, the processing logic outputs, by the PLL 108, an output signal.

At block 506, the processing logic receives, by an interface controller 102 of the first component 105, the input clock signal and the output signal from the PLL 108. In one embodiment, the interface controller 102 is coupled to the PLL 108.

At block 508, the processing logic generates, by a clock-management state machine 144 of the interface controller 102, a speed-switch packet;

At block 510, the processing logic transmits, by a transmitter 154 coupled to the interface controller 102, a first plurality of packets to a second component 110 at a clock rate based on the clock signal via a mid-speed interface 115. In one embodiment, the mid-speed interface 115 is a serial interface.

At block 512, the processing logic transmits, by the transmitter 154, the speed-switch packet to the second component 110 via the mid-speed interface 115. In one embodiment, the processing logic transmits the speed-switch packet subsequent to the first plurality of packets.

At block 514, the processing logic transmits, by the transmitter 154, a second plurality of packets to the second component 110 via the mid-speed interface 115 at a PLL rate based on the output signal, wherein the PLL rate is greater than the clock rate. In one embodiment, transmitting the second plurality of packets at the PLL rate is in response to the transmitting of the speed-switch packet to the second component 110. In one embodiment, the transmitter 154 uses a data clock and the receiver 164 uses a PLL clock. At power up, first component 105 and second component 110 start at a slow speed (e.g., transmitter transmits at about 4 MHz and receiver receives at about 38.4 MHz). The transmitter 154 may transmit a few packets before sending a speed switch packet, after which the transmitter 154 transmits at 40 MHz clock (DDR—80 Mb/sec) and receiver 174 changes clock to PLL at 624 MHz.

FIG. 5B is a flow diagram of a method 550 of transmission via a mid-speed interface 115, according to another embodiment. Method 550 may be performed by processing logic that may include hardware (e.g., circuitry, dedicated logic, programmable logic, microcode, etc.), software (such as instructions run on a processor, a general purpose computer system, or a dedicated machine), firmware, microcode, or a combination thereof. In one embodiment, method 550 may be performed, in part, by processor 605 of FIG. 6.

For simplicity of explanation, the method 550 is depicted and described as a series of acts. However, acts in accordance with this disclosure can occur in various orders and/or concurrently and with other acts not presented and described herein. Furthermore, not all illustrated acts may be performed to implement the method 550 in accordance with the disclosed subject matter. In addition, those skilled in the art will understand and appreciate that the method 550 could alternatively be represented as a series of interrelated states via a state diagram or events.

Referring to FIG. 5B, at 552 the processing logic receives, by a phase-locked loop (PLL) 128 of a second component 110, an input clock signal.

At block 554, the processing logic outputs, by the PLL 128, an output signal.

At block 556, the processing logic receives, by an interface controller 122 of the second component 110, the input clock signal and the output signal from the PLL 128. In one embodiment, the interface controller 122 is coupled to the PLL 128.

At block 558, the processing logic receives, by a receiver 174 coupled to the interface controller 122, a first plurality of packets from a first component 105 at a clock rate via a mid-speed interface 115. In one embodiment, the mid-speed interface 115 is a serial interface.

At block 560, the processing logic receives, by the receiver 164, a speed-switch packet from the first component 105 via the mid-speed interface 115. In one embodiment, the processing logic receives the speed-switch packet subsequent to the first plurality of packets.

At block 562, the processing logic receives, by the receiver 164, a second plurality of packets from the second component 110 via the mid-speed interface 115 at a PLL rate based on the output signal, wherein the PLL rate is greater than the clock rate.

Referring to FIG. 6, an embodiment of a computer system 600 with multiple interconnects with a mid-speed interface is illustrated. System 600 includes processor 605 and system memory 610 coupled to controller hub 615. Processor 605 includes any processing element, such as a microprocessor, a host processor, an embedded processor, a co-processor, or other processor. Processor 605 is coupled to controller hub 615 by an interface 606 (e.g., front-side bus (FSB), and so forth). In one embodiment, interface 606 is a serial point-to-point interconnect as described below. In another embodiment, interface 606 includes a serial, differential interconnect architecture that is compliant with different interconnect standard.

System memory 610 includes any memory device, such as random access memory (RAM), non-volatile (NV) memory, or other memory accessible by devices in system 600. In one embodiment, processor 605 interfaces directly to system memory 610. In another embodiment, processor 605 is coupled to system memory 610 through controller hub 615. System memory 610 may be coupled to controller hub 615 through memory interface 616. Examples of a memory interface include a double-data rate (DDR) memory interface, a dual-channel DDR memory interface, and a dynamic RAM (DRAM) memory interface.

In one embodiment, controller hub 615 is a root hub, root complex, or root controller in an interconnection hierarchy. Examples of controller hub 615 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 605, while controller 615 is to communicate with I/O devices, in a similar manner as described below. In some embodiments, peer-to-peer routing is optionally supported through root complex 615.

Here, controller hub 615 is coupled to switch/bridge 620 through serial link 619. Input/output modules 617 and 621, which may also be referred to as interfaces/ports 617 and 621, include/implement a layered protocol stack to provide communication between controller hub 615 and switch 620. In one embodiment, multiple devices are capable of being coupled to switch 620.

Switch/bridge 620 routes packets/messages from device 625 upstream, i.e. up a hierarchy towards a root complex, to controller hub 615 and downstream, i.e. down a hierarchy away from a root controller, from processor 605 or system memory 610 to device 625. Switch 620, in one embodiment, is referred to as a logical assembly of multiple virtual bridge devices. Device 625 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, a camera, an RF component, and other input/output devices. Such a device may be referred to as an endpoint. Although not specifically shown, device 625 may include a bridge to support other devices.

Graphics accelerator 630 is also coupled to controller hub 615 through serial link 632. In one embodiment, graphics accelerator 630 is coupled to an MCH, which is coupled to an ICH. Switch 620, and accordingly I/O device 625, is then coupled to the ICH. I/O modules 631 and 618 are also to implement a layered protocol stack to communicate between graphics accelerator 630 and controller hub 615. Similar to the MCH discussion above, a graphics controller or the graphics accelerator 630 may be integrated in processor 605.

I/O device 625 includes an interface 626 and switch/bridge 620 includes an interface 622. Interface 626 is coupled to interface 622 via serial link 623. Interface 626 or I/O device 625 may include second component 110 (e.g., peripheral device). Switch/bridge 620 or interface 622 may include a first component 105. Controller hub 615 or interface 617 may include first component 105. Interface 621 on switch 620 may include a second component 110. Interface 622 may send a first plurality of packets at a clock rate to interface 626, interface 622 may send a speed-switch packet to interface 626, and interface 622 may send a second plurality of packets to interface 626 at a PLL rate.

In one embodiment, short range wireless engines including a WLAN unit and a Bluetooth® unit may couple to processor 605 via a mid-speed interface 115.

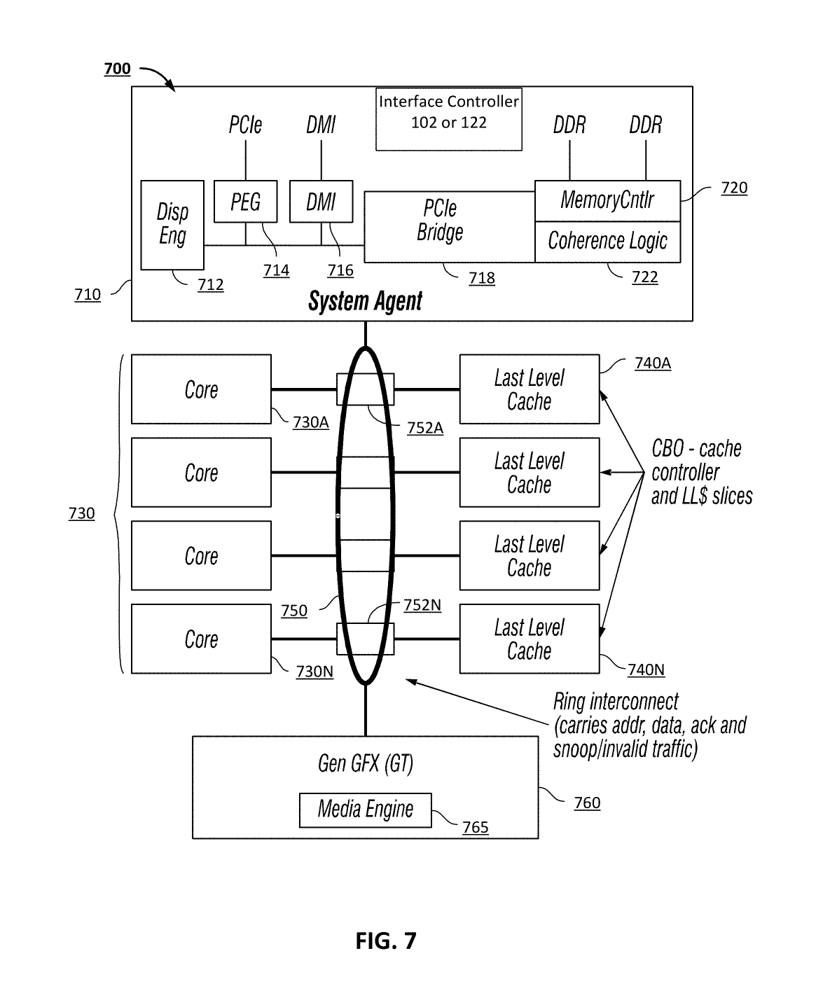

Referring now to FIG. 7, shown is a block diagram of an embodiment of a multicore processor. As shown in the embodiment of FIG. 7, processor 700 includes multiple domains. Specifically, a core domain 730 includes a plurality of cores 730A-730N, a graphics domain 760 includes one or more graphics engines having a media engine 765, and a system agent domain 710.

In various embodiments, system agent domain 710 handles power control events and power management, such that individual units of domains 730 and 760 (e.g. cores and/or graphics engines) are independently controllable to dynamically operate at an appropriate power mode/level (e.g. active, turbo, sleep, hibernate, deep sleep, or other Advanced Configuration Power Interface like state) in light of the activity (or inactivity) occurring in the given unit. Each of domains 730 and 760 may operate at different voltage and/or power, and furthermore the individual units within the domains each potentially operate at an independent frequency and voltage. Note that while only shown with three domains, understand the scope of the present disclosure is not limited in this regard and additional domains may be present in other embodiments.

As shown, each core 730 further includes low level caches in addition to various execution units and additional processing elements. Here, the various cores are coupled to each other and to a shared cache memory that is formed of a plurality of units or slices of a last level cache (LLC) 740A-740N; these LLCs often include storage and cache controller functionality and are shared amongst the cores, as well as potentially among the graphics engine too.

As seen, a ring interconnect 750 couples the cores together, and provides interconnection between the core domain 730, graphics domain 760 and system agent circuitry 710, via a plurality of ring stops 752A-752N, each at a coupling between a core and LLC slice. As seen in FIG. 7, interconnect 750 is used to carry various information, including address information, data information, acknowledgement information, and snoop/invalid information. Although a ring interconnect is illustrated, any known on-die interconnect or fabric may be utilized. As an illustrative example, some of the fabrics discussed above (e.g. another on-die interconnect, Intel® On-chip System Fabric (IOSF), an Advanced Microcontroller Bus Architecture (AMBA) interconnect, a multi-dimensional mesh fabric, or other known interconnect architecture) may be utilized in a similar fashion.

As further depicted, system agent domain 710 includes display engine 712 which is to provide control of and an interface to an associated display. System agent domain 710 may include other units, such as: an integrated memory controller 720 that provides for an interface to a system memory (e.g., a DRAM implemented with multiple DIMMs; coherence logic 722 to perform memory coherence operations. Multiple interfaces may be present to enable interconnection between the processor and other circuitry. For example, in one embodiment at least one direct media interface (DMI) 716 interface is provided as well as one or more PCIe® interfaces 714 (e.g., PCIe® Graphics (PEG) port interfaces for PEG adapters). The display engine and these interfaces typically couple to memory via a PCIe® bridge 718.

In one embodiment, system agent domain 710 includes an interface controller 102 or 122. In one embodiment, system agent domain 710 includes a first component 105 and system agent domain 710 is coupled to a second component 110 via a mid-speed interface. In another embodiment, system agent domain 710 includes a second component 110 and system agent domain 710 is coupled to a first component 105 via a mid-speed interface. Still further, to provide for communications between other agents, such as additional processors or other circuitry, one or more other interfaces (e.g. an Intel® Quick Path Interconnect (QPI) fabric) may be provided.

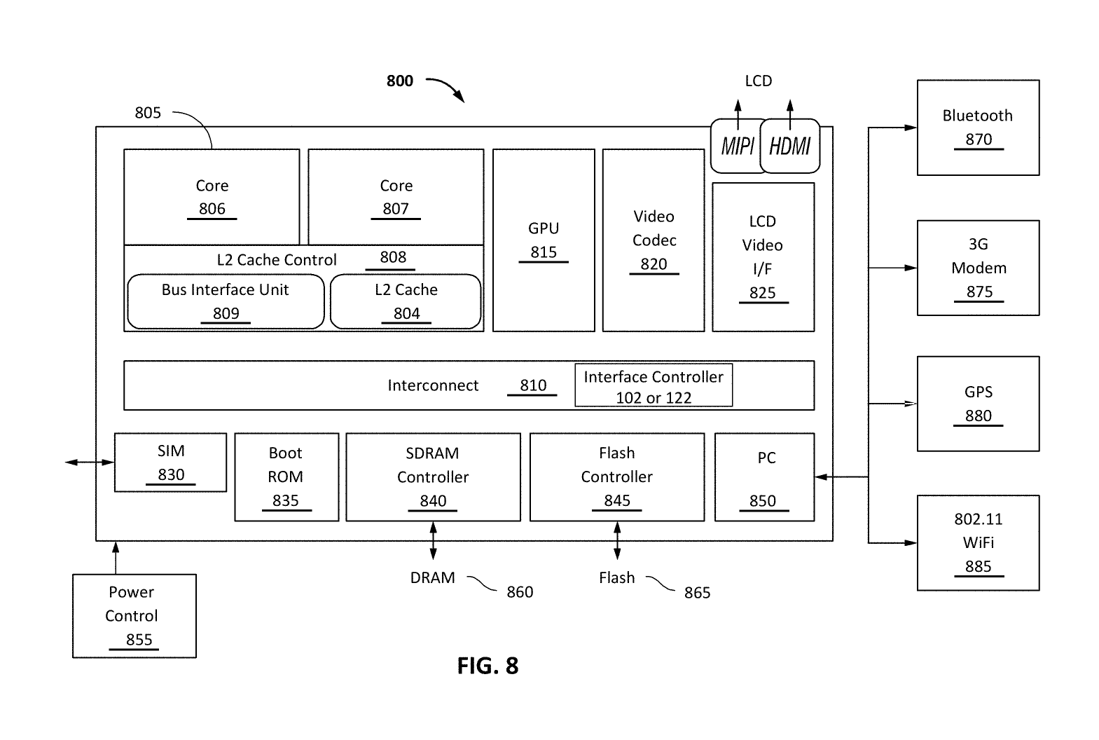

Turning next to FIG. 8, an embodiment of a system on-chip (SOC) design in accordance with the disclosures is depicted. As a specific illustrative example, SOC 800 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network. In another embodiment SOC 800 is first component 105.

Here, SOC 800 includes 2 cores—806 and 807. Similar to the discussion above, cores 806 and 807 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 806 and 807 are coupled to cache control 808 that is associated with bus interface unit 809 and L2 cache 804 to communicate with other parts of system 800. Interconnect 810 includes an on-chip interconnect, such as an IOSF, AMBA, or other interconnect discussed above, which potentially implements one or more aspects of the described disclosure. In one embodiment, interconnect 810 includes interface controller 102 or 122.

Interface 810 provides communication channels to the other components, such as a Subscriber Identity Module (SIM) 830 to interface with a SIM card, a boot rom 835 to hold boot code for execution by cores 806 and 807 to initialize and boot SOC 800, a SDRAM controller 840 to interface with external memory (e.g. DRAM 860), a flash controller 845 to interface with non-volatile memory (e.g. Flash 865), a peripheral control Q1650 (e.g. Serial Peripheral Interface) to interface with peripherals, video codecs 820 and Video interface 825 to display and receive input (e.g. touch enabled input), GPU 815 to perform graphics related computations, etc. Any of these interfaces may incorporate aspects of the disclosure described herein.

Interconnect 810 may connect with another component via a mid-speed interface 115 (e.g., on-chip interconnect, IOSF, AMBA, or other interconnect).

In addition, the system illustrates peripherals for communication, such as a Bluetooth® module 870, 3G modem 875, GPS 885, and Wi-Fi® 885. Note as stated above, a UE includes a radio for communication. As a result, these peripheral communication modules are not all required. However, in a UE some form a radio for external communication is to be included. In one embodiment, one or more of the peripherals (e.g., Bluetooth® module 870, 3G modem 875, GPS 885, and Wi-Fi® 885) may be second component 110 and may be coupled to SOC 800 via a mid-speed interface 115.

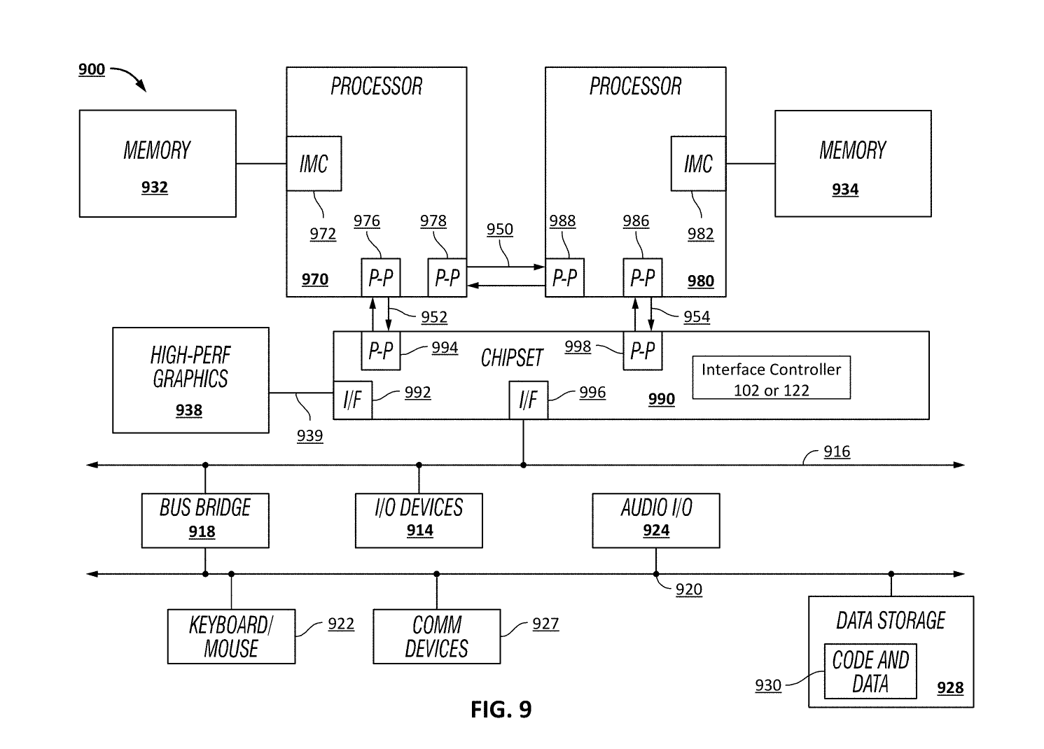

Referring now to FIG. 9, shown is a block diagram of a system 900 in accordance with an embodiment of the disclosure. As shown in FIG. 9, multiprocessor system 900 is a point-to-point interconnect system, and includes a first processor 970 and a second processor 980 coupled via a point-to-point interconnect 950. Each of processors 970 and 980 may be some version of a processor. In one embodiment, 952 and 954 are part of a serial, point-to-point coherent interconnect fabric, such as Intel® Quick Path Interconnect (QPI) architecture. As a result, the disclosure may be implemented within the QPI architecture.

While shown with only two processors 970, 980, it is to be understood that the scope of the present disclosure is not so limited. In other embodiments, one or more additional processors may be present in a given processor.

Processors 970 and 980 are shown including integrated memory controller units 972 and 982, respectively. Processor 970 also includes as part of its bus controller units point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, IMCs 972 and 982 couple the processors to respective memories, namely a memory 932 and a memory 934, which may be portions of main memory locally attached to the respective processors.

Processors 970, 980 each exchange information with a chipset 990 via individual P-P interfaces 952, 954 using point to point interface circuits 976, 994, 986, 998. Chipset 990 also exchanges information with a high-performance graphics circuit 938 via an interface circuit 992 along a high-performance graphics interconnect 939. In one embodiment, chipset 990 includes protocol stack 90 with time offset validation. In another embodiment, chipset 990 includes protocol stack 130 with time offset validation.

Chipset 990 may connect with another component via a mid-speed interface 115 (e.g., P-P interface 952, P-P interface 954, high-performance graphics interconnect 939, bus 916, and so forth). In one embodiment, chipset 990 is a first component 105 including an interface controller 102 coupled to a second component 110 via a mid-speed interface 115. In another embodiment, chipset 990 is a second component 110 including an interface controller 122 coupled to a first component 105 via a mid-speed interface 115.

A shared cache (not shown) may be included in either processor or outside of both processors; yet connected with the processors via P-P interconnect, such that either or both processors' local cache information may be stored in the shared cache if a processor is placed into a low power mode.

Chipset 990 may be coupled to a first bus 916 via an interface 996. In one embodiment, first bus 916 may be a Peripheral Component Interconnect (PCI) bus, or a bus such as a PCI Express bus or another third generation I/O interconnect bus, although the scope of the present disclosure is not so limited.

As shown in FIG. 9, various I/O devices 914 are coupled to first bus 916, along with a bus bridge 918 which couples first bus 916 to a second bus 920. In one embodiment, second bus 920 includes a low pin count (LPC) bus. Various devices are coupled to second bus 920 including, for example, a keyboard and/or mouse 922, communication devices 927 and a storage unit 928 such as a disk drive or other mass storage device which often includes instructions/code and data 930, in one embodiment. Further, an audio I/O 924 is shown coupled to second bus 920. Note that other architectures are possible, where the included components and interconnect architectures vary. For example, instead of the point-to-point architecture of FIG. 9, a system may implement a multi-drop bus or other such architecture.

The following examples pertain to further embodiments.

Example 1 is a first component comprising: phase-locked loop (PLL) to receive an input clock signal and to output an output signal; an interface controller coupled to the PLL, wherein the interface controller comprises a clock-management state machine, the interface controller to: receive the input clock signal; receive the output signal from the PLL; and generate, by the clock-management state machine, a speed-switch packet; a transmitter coupled to the interface controller, the transmitter to: transmit a first plurality of packets to a second component at a clock rate based on the clock signal via a mid-speed interface, wherein the mid-speed interface is a serial interface; transmit the speed-switch packet to the second component via the mid-speed interface subsequent to the first plurality of packets; and transmit a second plurality of packets to the second component via the mid-speed interface at a PLL rate based on the output signal in response to transmission of the speed-switch packet, wherein the PLL rate is greater than the clock rate.

In Example 2, the subject matter of Example 1, wherein the clock rate is 2 to 5 Mbits/second and the PLL rate is 20 to 200 Mbits/second.

In Example 3, the subject matter of Examples 1-2, wherein the interface controller further comprises a power-management state machine, the interface controller to: generate, by the power-management state machine, a going-to-park packet; instruct the transmitter to transmit the going-to-park packet to the second component; and change the first component from an operating power state to a park power state in response to transmission of the going-to-park packet to the second component, wherein the park power state is lower than the operating power state.

In Example 4, the subject matter of Examples 1-3, wherein the interface controller to: generate, by the power-management state machine, a going-out-of-park sequence; instruct a pad coupled to the transmitter to transmit the going-out-of-park sequence to the second component; and change the first component from the park power state to the operating power state in response to transmission of the going-out-of-park sequence to the second component.

In Example 5, the subject matter of Examples 1-4, wherein the interface controller is coupled to a receiver, the receiver to: receive a going-out-of-park sequence from the second component; and change the first component from the park power state to the operating power state in response to receiving the going-out-of-park sequence.

In Example 6, the subject matter of Examples 1-5, wherein the first component is a system on a chip (SoC) and the second component is a peripheral device.

In Example 7, the subject matter of Examples 1-6, wherein the interface controller is coupled to a receiver, the interface controller is to: detect a received sequence of a specified number of same bits; and self-reset the receiver when the received sequence is detected.

In Example 8, the subject matter of Examples 1-7, further comprising a transceiver comprising the transmitter and a receiver, wherein: the receiver is coupled to the interface controller; the transmitter is to transmit fixed length packets, each fixed length packet transmitted by the transmitter or received by the receiver does not include a stop bit; the transceiver to establish a full duplex communication channel; and the transceiver to perform a handshake with the second component.

In Example 9, the subject matter of Examples 1-8, wherein the first component comprises a first terminal and a second terminal, the first terminal to be coupled to a first data line of the mid-speed interface and the second terminal to be coupled to a second data line of the mid-speed interface.

In Example 10, the subject matter of Examples 1-9, wherein the PLL is a system PLL that outputs the output signal to a circuit in addition to the interface controller.

Example 11 is a second component comprising: phase-locked loop (PLL) to receive an input clock signal and to output an output signal; an interface controller coupled to the PLL, wherein the interface controller comprises a clock-management state machine, the interface controller to: receive the input clock signal; and receive the output signal from the PLL; a receiver coupled to the interface controller, the receiver to: receive a first plurality of packets from a first component at a clock rate via a mid-speed interface, wherein the mid-speed interface is a serial interface; receive a speed-switch packet from the first component via the mid-speed interface subsequent to the first plurality of packets; and receive a second plurality of packets from the first component via the mid-speed interface at a first PLL rate, wherein the first PLL rate is greater than the clock rate; and a transmitter coupled to the interface controller, the transmitter to transmit a third plurality of packets to the first component via the mid-speed interface at a second PLL rate based on the output signal in response to receiving the speed-switch packet.

In Example 12, the subject matter of Example 11, wherein the clock rate is 2 to 5 Mbits/second and the PLL rate is 20 to 200 Mbits/second.

In Example 13, the subject matter of Examples 11-12, wherein the interface controller further comprises a power-management state machine, the interface controller to: receive, via the receiver, a going-to-park packet from the first component; and change the second component from an operating power state to a park power state in response to receiving the going-to-park packet from the first component, wherein the park power state is lower than the operating power state.

In Example 14, the subject matter of Examples 11-13, wherein the interface controller to: generate, by the power-management state machine, a going-out-of-park sequence; and instruct a pad coupled to the transmitter to transmit the going-out-of-park sequence to the first component; and change the second component from the park power state to the operating power state in response to transmission of the going-out-of-park sequence to the first component.

In Example 15, the subject matter of Examples 11-14, wherein the interface controller is to: receive a going-out-of-park sequence from the first component; and change the second component from the park power state to the operating power state in response to receiving the going-out-of-park sequence.

In Example 16, the subject matter of Examples 11-15, wherein the first component is a system on a chip (SoC) and the second component is a peripheral device.

In Example 17, the subject matter of Examples 11-16, wherein the interface controller is to: detect a received sequence of a specified number of same bits; and self-reset the receiver when the received sequence is detected.

In Example 18, the subject matter of Examples 11-17, further comprising a transceiver comprising the transmitter and the receiver, wherein: the transmitter is to transmit fixed length packets, each fixed length packet transmitted by the transmitter or received by the receiver does not include a stop bit; the transceiver to establish a full duplex communication channel; and the transceiver to perform a full handshake with the second component.

In Example 19, the subject matter of Examples 11-18, wherein the second component comprises a first terminal and a second terminal, the first terminal to be coupled to a first data line of the mid-speed interface and the second terminal to be coupled to a second data line of the mid-speed interface.

In Example 20, the subject matter of Examples 11-19, wherein the PLL is a system PLL that outputs the output signal to a circuit in addition to the interface controller.

In Example 21, the subject matter of Examples 11-20, wherein the interface controller is to oversample signals received by the receiver.

Various embodiments can have different combinations of the structural features described above. For instance, all optional features of the components described above can also be implemented for various usages in SOC applications and can be implemented with respect to the method or process described herein and specifics in the examples can be used anywhere in one or more embodiments.

Example 22 is a method comprising: receiving, by a phase-locked loop (PLL) of a first component, an input clock signal; outputting, by the PLL, an output signal; receiving, by an interface controller of the first component, the input clock signal and the output signal from the PLL, wherein the interface controller is coupled to the PLL; generating, by a clock-management state machine of the interface controller, a speed-switch packet; transmitting, by a transmitter coupled to the interface controller, a first plurality of packets to a second component at a clock rate based on the clock signal via a mid-speed interface, the mid-speed interface comprising a serial interface; transmitting, by the transmitter, the speed-switch packet to the second component via the mid-speed interface subsequent to the first plurality of packets; and transmitting, by the transmitter, a second plurality of packets to the second component via the mid-speed interface at a PLL rate based on the output signal in response to the transmitting of the speed-switch packet to the second component, wherein the PLL rate is greater than the clock rate.

In Example 23, the subject matter of Example 22, further comprising: generate, by a power-management state machine of the interface controller, a going-to-park packet; transmitting, by the transmitter, the going-to-park packet to the second component; and changing the first component from an operating power state to a park power state in response to transmission of the going-to-park packet to the second component, wherein the park power state is lower than the operating power state.

Example 24 is a method comprising: receiving, by a phase-locked loop (PLL) of a second component, an input clock signal; outputting, by the PLL, an output signal; receiving, by an interface controller of the second component, the input clock signal and the output signal from the PLL, wherein the interface controller is coupled to the PLL; receiving, by a receiver coupled to the interface controller, a first plurality of packets from a first component at a clock rate via a mid-speed interface, the mid-speed interface comprising a serial interface; receiving, by the receiver, a speed-switch packet from the interface controller subsequent to the first plurality of packets; receiving, by the receiver, a second plurality of packets from the first component via the mid-speed interface at a first PLL rate, wherein the first PLL rate is greater than the clock rate; and transmitting, by a transmitter, a third plurality of packets to the first component via the mid-speed interface at a second PLL rate based on the output signal in response to the receiving of the speed-switch packet.

In Example 25, the subject matter of Example 24, further comprising: generating, by a power-management state machine of the interface controller, a going-out-of-park sequence; transmitting, by a pad coupled to the transmitter, the going-out-of-park sequence to the first component; and changing the second component from a park power state to an operating power state in response to transmission of the going-out-of-park sequence to the first component.

Various embodiments can have different combinations of the structural features described above. For instance, all optional features of the methods described above can also be implemented for various usages in SOC applications and can be implemented with respect to an interface described herein and specifics in the examples can be used anywhere in one or more embodiments.

While the present disclosure has been described with respect to a limited number of embodiments, those skilled in the art will appreciate numerous modifications and variations therefrom. It is intended that the appended claims cover all such modifications and variations as fall within the true spirit and scope of this present disclosure.

In the description herein, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation, etc. in order to provide a thorough understanding of the present disclosure. It will be apparent, however, to one skilled in the art that these specific details need not be employed to practice the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system have not been described in detail in order to avoid unnecessarily obscuring the present disclosure.

The embodiments may be described with reference to timestamp validation of components in solid-state memory devices in specific integrated circuits, such as in computing platforms or microprocessors. The embodiments can also be applicable to other types of integrated circuits and programmable logic devices. For example, the disclosed embodiments are not limited to desktop computer systems or portable computers, such as the Intel® Ultrabooks™ computers, and can be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. It is described that the system can be any kind of computer or embedded system. The disclosed embodiments can especially be used for low-end devices, like wearable devices (e.g., watches), electronic implants, sensory and control infrastructure devices, controllers, supervisory control and data acquisition (SCADA) systems, or the like. Moreover, the apparatuses, methods, and systems described herein are not limited to physical computing devices, but can also relate to software optimizations for energy conservation and efficiency. As will become readily apparent in the description below, the embodiments of methods, apparatuses, and systems described herein (whether in reference to hardware, firmware, software, or a combination thereof) are vital to a ‘green technology’ future balanced with performance considerations.

Although the embodiments herein are described with reference to a processor, other embodiments are applicable to other types of integrated circuits and logic devices. Similar techniques and teachings of embodiments of the present disclosure can be applied to other types of circuits or semiconductor devices that can benefit from higher pipeline throughput and improved performance. The teachings of embodiments of the present disclosure are applicable to any processor or machine that performs data manipulations. However, the present disclosure is not limited to processors or machines that perform 512 bit, 256 bit, 128 bit, 64 bit, 32 bit, or 16 bit data operations and can be applied to any processor and machine in which manipulation or management of data is performed. In addition, the description herein provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

Although the below examples describe instruction handling and distribution in the context of execution units and logic circuits, other embodiments of the present disclosure can be accomplished by way of a data or instructions stored on a machine-readable, tangible medium, which when performed by a machine cause the machine to perform functions consistent with at least one embodiment of the disclosure. In one embodiment, functions associated with embodiments of the present disclosure are embodied in machine-executable instructions. The instructions can be used to cause a general-purpose or special-purpose processor that is programmed with the instructions to perform the steps of the present disclosure. Embodiments of the present disclosure can be provided as a computer program product or software which can include a machine or computer-readable medium having stored thereon instructions which can be used to program a computer (or other electronic devices) to perform one or more operations according to embodiments of the present disclosure. Alternatively, operations of embodiments of the present disclosure might be performed by specific hardware components that contain fixed-function logic for performing the operations, or by any combination of programmed computer components and fixed-function hardware components.

Instructions used to program logic to perform embodiments of the disclosure can be stored within a memory in the system, such as DRAM, cache, flash memory, or other storage. Furthermore, the instructions can be distributed via a network or by way of other computer readable media. Thus a machine-readable medium can include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design can go through various stages, from creation to simulation to fabrication. Data representing a design can represent the design in a number of manners. First, as is useful in simulations, the hardware can be represented using a hardware description language or another functional description language. Additionally, a circuit level model with logic and/or transistor gates can be produced at some stages of the design process. Furthermore, most designs, at some stage, reach a level of data representing the physical placement of various devices in the hardware model. In the case where conventional semiconductor fabrication techniques are used, the data representing the hardware model can be the data specifying the presence or absence of various features on different mask layers for masks used to produce the integrated circuit. In any representation of the design, the data can be stored in any form of a machine readable medium. A memory or a magnetic or optical storage such as a disc can be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider can store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) can refer to the combination of the microcontroller and the non-transitory medium. Often module boundaries that are illustrated as separate commonly vary and potentially overlap. For example, a first and a second module can share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate can provide a 0 or a 1 during operation. But a logic gate ‘configured to’ provide an enable signal to a clock does not include every potential logic gate that can provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, can be capable of holding a single logical value or multiple logical values. However, other representations of values in computer systems have been used. For example the decimal number ten can also be represented as a binary value of 1010 and a hexadecimal letter A. Therefore, a value includes any representation of information capable of being held in a computer system.

Moreover, states can be represented by values or portions of values. As an example, a first value, such as a logical one, can represent a default or initial state, while a second value, such as a logical zero, can represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values can be utilized to represent any number of states.

The embodiments of methods, hardware, software, firmware or code set forth above can be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that can receive information there from.

Instructions used to program logic to perform embodiments of the disclosure can be stored within a memory in the system, such as DRAM, cache, flash memory, or other storage. Furthermore, the instructions can be distributed via a network or by way of other computer readable media. Thus a machine-readable medium can include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

In the foregoing specification, a detailed description has been given with reference to specific exemplary embodiments. It will, however, be evident that various modifications and changes can be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but can refer to different and distinct embodiments, as well as potentially the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “defining,” “determining,” “issuing,” “linking,” “associating,” “obtaining,” “authenticating,” “prohibiting,” “executing,” “requesting,” “communicating,” “setting,” “receiving,” “generating,” “transmitting,” “changing,” “putting,” “detecting,” “self-resetting,” “resetting,” “establishing,” “performing,” “outputting,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and can not necessarily have an ordinal meaning according to their numerical designation.

What is claimed is:

1. A first component comprising:
phase-locked loop (PLL) to receive an input clock signal and to output an output signal;
an interface controller coupled to the PLL, wherein the interface controller comprises a clock-management state machine, the interface controller to:
receive the input clock signal;
receive the output signal from the PLL; and
generate, by the clock-management state machine, a speed-switch packet;
a transmitter coupled to the interface controller, the transmitter to:
transmit a first plurality of packets to a second component at a clock rate based on the clock signal via a mid-speed interface, wherein the mid-speed interface is a serial interface;
transmit the speed-switch packet to the second component via the mid-speed interface subsequent to the first plurality of packets; and
transmit a second plurality of packets to the second component via the mid-speed interface at a PLL rate based on the output signal in response to transmission of the speed-switch packet, wherein the PLL rate is greater than the clock rate.

2. The first component of claim 1, wherein the clock rate is 2 to 5 Mbits/second and the PLL rate is 20 to 200 Mbits/second.

3. The first component of claim 1, wherein the interface controller further comprises a power-management state machine, the interface controller to:
generate, by the power-management state machine, a going-to-park packet;
instruct the transmitter to transmit the going-to-park packet to the second component; and
change the first component from an operating power state to a park power state in response to transmission of the going-to-park packet to the second component, wherein the park power state is lower than the operating power state.

4. The first component of claim 3, wherein the interface controller to:
generate, by the power-management state machine, a going-out-of-park sequence;
instruct a pad coupled to the transmitter to transmit the going-out-of-park sequence to the second component; and
change the first component from the park power state to the operating power state in response to transmission of the going-out-of-park sequence to the second component.

5. The first component of claim 3, wherein the interface controller is coupled to a receiver, the receiver to:
receive a going-out-of-park sequence from the second component; and
change the first component from the park power state to the operating power state in response to receiving the going-out-of-park sequence.

6. The first component of claim 1, wherein the first component is a system on a chip (SoC) and the second component is a peripheral device.

7. The first component of claim 1, wherein the interface controller is coupled to a receiver, the interface controller is to:
detect a received sequence of a specified number of same bits; and
self-reset the receiver when the received sequence is detected.

8. The first component of claim 1, further comprising a transceiver comprising the transmitter and a receiver, wherein:
the receiver is coupled to the interface controller;
the transmitter is to transmit fixed length packets, each fixed length packet transmitted by the transmitter or received by the receiver does not include a stop bit;
the transceiver to establish a full duplex communication channel; and
the transceiver to perform a handshake with the second component.

9. The first component of claim 1, wherein the first component comprises a first terminal and a second terminal, the first terminal to be coupled to a first data line of the mid-speed interface and the second terminal to be coupled to a second data line of the mid-speed interface.

10. The first component of claim 1, wherein the PLL is a system PLL that outputs the output signal to a circuit in addition to the interface controller.

11. A second component comprising:
phase-locked loop (PLL) to receive an input clock signal and to output an output signal;
an interface controller coupled to the PLL, wherein the interface controller comprises a clock-management state machine, the interface controller to:
receive the input clock signal; and
receive the output signal from the PLL;
a receiver coupled to the interface controller, the receiver to:
receive a first plurality of packets from a first component at a clock rate via a mid-speed interface, wherein the mid-speed interface is a serial interface;
receive a speed-switch packet from the first component via the mid-speed interface subsequent to the first plurality of packets; and
receive a second plurality of packets from the first component via the mid-speed interface at a first PLL rate, wherein the first PLL rate is greater than the clock rate; and
a transmitter coupled to the interface controller, the transmitter to transmit a third plurality of packets to the first component via the mid-speed interface at a second PLL rate based on the output signal in response to receiving the speed-switch packet.

12. The second component of claim 11, wherein the clock rate is 2 to 5 Mbits/second and the PLL rate is 20 to 200 Mbits/second.

13. The second component of claim 11, wherein the interface controller further comprises a power-management state machine, the interface controller to:
receive, via the receiver, a going-to-park packet from the first component; and
change the second component from an operating power state to a park power state in response to receiving the going-to-park packet from the first component, wherein the park power state is lower than the operating power state.

14. The second component of claim 13, wherein the interface controller to:
generate, by the power-management state machine, a going-out-of-park sequence; and
instruct a pad coupled to the transmitter to transmit the going-out-of-park sequence to the first component; and
change the second component from the park power state to the operating power state in response to transmission of the going-out-of-park sequence to the first component.

15. The second component of claim 13, wherein the interface controller is to:
receive a going-out-of-park sequence from the first component; and
change the second component from the park power state to the operating power state in response to receiving the going-out-of-park sequence.

16. The second component of claim 11, wherein the first component is a system on a chip (SoC) and the second component is a peripheral device.

17. The second component of claim 11, wherein the interface controller is to:
detect a received sequence of a specified number of same bits; and
self-reset the receiver when the received sequence is detected.

18. The second component of claim 11, further comprising a transceiver comprising the transmitter and the receiver, wherein:
the transmitter is to transmit fixed length packets, each fixed length packet transmitted by the transmitter or received by the receiver does not include a stop bit;
the transceiver to establish a full duplex communication channel; and
the transceiver to perform a full handshake with the second component.

19. The second component of claim 11, wherein the second component comprises a first terminal and a second terminal, the first terminal to be coupled to a first data line of the mid-speed interface and the second terminal to be coupled to a second data line of the mid-speed interface.

20. The second component of claim 11, wherein the PLL is a system PLL that outputs the output signal to a circuit in addition to the interface controller.

21. The second component of claim 11, wherein the interface controller is to oversample signals received by the receiver.

22. A method comprising:
receiving, by a phase-locked loop (PLL) of a first component, an input clock signal;
outputting, by the PLL, an output signal;
receiving, by an interface controller of the first component, the input clock signal and the output signal from the PLL, wherein the interface controller is coupled to the PLL;
generating, by a clock-management state machine of the interface controller, a speed-switch packet;
transmitting, by a transmitter coupled to the interface controller, a first plurality of packets to a second component at a clock rate based on the clock signal via a mid-speed interface, the mid-speed interface comprising a serial interface;
transmitting, by the transmitter, the speed-switch packet to the second component via the mid-speed interface subsequent to the first plurality of packets; and
transmitting, by the transmitter, a second plurality of packets to the second component via the mid-speed interface at a PLL rate based on the output signal in response to the transmitting of the speed-switch packet to the second component, wherein the PLL rate is greater than the clock rate.

23. The method of claim 22, further comprising:
generate, by a power-management state machine of the interface controller, a going-to-park packet;
transmitting, by the transmitter, the going-to-park packet to the second component; and
changing the first component from an operating power state to a park power state in response to transmission of the going-to-park packet to the second component, wherein the park power state is lower than the operating power state.

24. A method comprising:
receiving, by a phase-locked loop (PLL) of a second component, an input clock signal;
outputting, by the PLL, an output signal;
receiving, by an interface controller of the second component, the input clock signal and the output signal from the PLL, wherein the interface controller is coupled to the PLL;
receiving, by a receiver coupled to the interface controller, a first plurality of packets from a first component at a clock rate via a mid-speed interface, the mid-speed interface comprising a serial interface;
receiving, by the receiver, a speed-switch packet from the interface controller subsequent to the first plurality of packets;
receiving, by the receiver, a second plurality of packets from the first component via the mid-speed interface at a first PLL rate, wherein the first PLL rate is greater than the clock rate; and
transmitting, by a transmitter, a third plurality of packets to the first component via the mid-speed interface at a second PLL rate based on the output signal in response to the receiving of the speed-switch packet.

25. The method of claim 24, further comprising:
generating, by a power-management state machine of the interface controller, a going-out-of-park sequence;
transmitting, by a pad coupled to the transmitter, the going-out-of-park sequence to the first component; and
changing the second component from a park power state to an operating power state in response to transmission of the going-out-of-park sequence to the first component.
